(19) United States
(12) Patent Application Publication
(10) Pub. No.: US 2016/0161636 A1
(43) Pub. Date: Jun. 9, 2016

(54) Rain Gauge

(71) Applicant: Harold Marlow, Urbana, IL (US)

(72) Inventor: Harold Marlow, Urbana, IL (US)

(21) Appl. No.: 14/560,683

(22) Filed: Dec. 4, 2014

(51) Int. Cl. G01W 1/14; E04D 13/064

(52) U.S. Cl. CPC G01W 1/14; E04D 13/064

(57) ABSTRACT

The present invention comprises a rain gauge system having an attachment section for disposition on guttering, a removable vessel section, and preferably, an extension stick for placing and removing the removable vessel.

### FIELD OF THE INVENTION

The present invention is a rain gauge utilizing a gutter mount.

### BRIEF DESCRIPTION OF THE DRAWINGS

FIG. 1 depicts a side view of a section of guttering with the attachment section of the preferred embodiment disposed thereon;

FIG. 2 also depicts a side view of the preferred embodiment with the attachment section disposed on the guttering and illustrating the manipulation of the vessel portion of the invention for disposition within the attachment section;

FIG. 3 depicts an alternate embodiment of the removable vessel of the invention disposed in the receiving cup, particularly depicting extensions for receipt of prongs disposed on a separate extension stick;

FIG. 4 depicts a side view of a partial cross section of guttering showing part of the attachment section of an alternate embodiment disposed thereon, specifically showing a clamp fittingly curved to the exterior wall of the gutter and utilizing end capped bolts to affix the clamp attachment to the gutter; and

FIG. 5 depicts a partial cross section of guttering showing a “split” c-clamp having two sections affixed together along facing rear walls and with a curved sidewall of the clamp fittingly curved to the exterior wall of the gutter.

FIG. 6 depicts a perspective view of the spring clamping attachment disposed over the gutter lip and applying pressure to the inner and outer sidewalls of a gutter.

FIG. 7 depicts a cross sectional view of the spring loaded clamping attachment disposed over the gutter lip and inner and outer sidewalls of the a gutter.

FIG. 8 depicts a cross sectional view of the spring loaded clamp with the rain gauge receiving cup and rain gauge collection section disposed within the receiving cup.

### REFERENCE NUMERALS

10 Gutter
12 Downspout of gutter
14 Interior sidewall of gutter
16 Exterior sidewall of gutter
18 Upper lip of exterior sidewall of gutter
20 Multi-part rain gauge
22 Attachment section of rain gauge
24 C-clamp
26, 26′ Opposing sidewalls of c-clamp
28 Rear/upper sidewall of c-clamp
29, 29′ Facing sidewall pieces of rear sidewall 28
30 Bore through exterior sidewall 16 of gutter 10
32 Gutter wall screw
34, 34′ End caps of screws 36, 36′
35 Upper edge of upper lip 18
36, 36′ Perpendicular screws/bolts of rear wall of c-clamp
37 screw/bolt
38 Rain gauge receiving cup
40 Top lip of receiving cup 38
42 Attachment screw of receiving cup
44 Collection section of rain gauge
46 Rain gauge vessel
48 Open end of receiving cup 38
50 Measuring marks
54 Extension stick
56 Attachment means of extension stick 54 to rain gauge vessel 44
58 Pronged extensions of extension stick 54
60 sidewall extensions vessel 46

### BACKGROUND OF THE INVENTION

The invention relates to rain gauges.

Rain gauges are known that include a rain collection vessel and gradation marks along the side of the vessel. These gauges are general provided with screw holes for attachment to a post for collection and measurement of rain.

While such mounting/set up means can be augmented to allow the user to observe the rainfall amount from a distance (with lighted displays or large numbers, as disclosed in U.S. Pat. No. 7,543,493 to Geschwender), this usually requires the device itself to be placed at a distance from the user's home to allow uninterrupted rain fall (from roof overhangs or trees).

Weather/nature monitoring is a significant activity in the lives of many of the population, including perhaps a disproportionate number of its aging members. For some of these members, walking even modest distances to observe and empty a rain gauge can be cumbersome. Some may have yards that do not lend themselves to an unimpeded rainfall area, or may utilize rental properties not allowing them to erect a post to dispose a rain gauge upon. Additionally, posts and stakes may create more difficulty for yard maintenance, requiring mowing or weeding around. Therefore it is clear that there is a need in the art for an easily reached device that can be located nearer a user's home, and which can be easily maintained.

The solution for those who cannot or prefer not to venture far from their door to maintain a rain gauge would be to place the device on the house. However, unimpeded or open access from the sky to the gauge is a must for accurate measurement. Placing the device in even a “seemingly” open spot, such as on an uncovered deck railing may still actually be significantly sheltered by the house itself, and skew the readings. However, many houses have areas along their roofline which would be sufficiently open to receive relatively accurate rainfall readings. Most people prefer not to permanently mount anything (for example, with screws) into the roof (for fear of leaks) or on an exterior wall of the house. A gutter mounting would allow the device to be open to the rain without damaging the roof or an exterior wall of the house.

However, mounting the device on a gutter presents a difficulty for less able-bodied members of the population in viewing and emptying the device. Many individuals cannot or prefer not to climb on ladders regularly (particularly in a wet environment after a rain). Therefore merely permanently attaching existing gauge devices currently available onto the guttering itself would present a need for use of a ladder each time an individual wished to read or empty the device.

### SUMMARY OF THE INVENTION

The present invention is a rain gauge having a guttering attachment section with an attached rain collection vessel receiving cup for receipt of a rain collection vessel (removably disposed within the rain collection vessel receiving cup) marked with the usual measuring indicia, and alternately having an extension stick to place and remove the rain collection vessel in the receiving cup. The guttering attachment preferably comprises a c-clamp having two opposing side walls with a nut and bolt or screw therethrough and one rear sidewall disposed perpendicularly to the other sidewalls. The nuts and bolts or screws can alternately have end caps for placement against an inside surface and against an outside surface of the exterior sidewall of guttering. The rear sidewall can rest upon an upper lip of a gutter, but can alternately have at least one of a bolt or screw through the rear wall of the c-clamp which then rests upon the upper lip of the gutter (and can have end caps). Alternately, one of the opposing c-clamp sidewalls can be curved for receipt of an outside surface of a gutter. Further, the nut(s) and bolt(s) or screw(s) can be disposed through that curved sidewall of the gutter or can rest against an outside surface of the gutter and can have end cap(s). The c-clamp rear wall can be two perpendicularly extending sections from the opposing side walls, laid one overtop of the other and affixed together to form the rear sidewall.

The rain vessel receiving cup can have a lip for affixing it to the guttering attachment section. It can also have drainage holes. It can be a ring or other geometric shape (like a rectangle or triangle) which corresponds to the outer wall shape of the rain collection vessel so that the vessel fits inside the “cup.”

The extension stick can be fixed to the rain collection vessel or removable. It can be extendable, by being foldable, hinged, or with sections fitting within one another, or other extendable devices known in the art. The stick is either attached to the vessel or attachable through some means such as having at least one prong for fitted receipt of the rain collection vessel.

### DESCRIPTION OF A PREFERRED EMBODIMENT

The present invention comprises a multi-part rain gauge for mounting onto the guttering of a house. This device allows for simple, easy removal of the rain vessel for reading and emptying without use of a ladder.

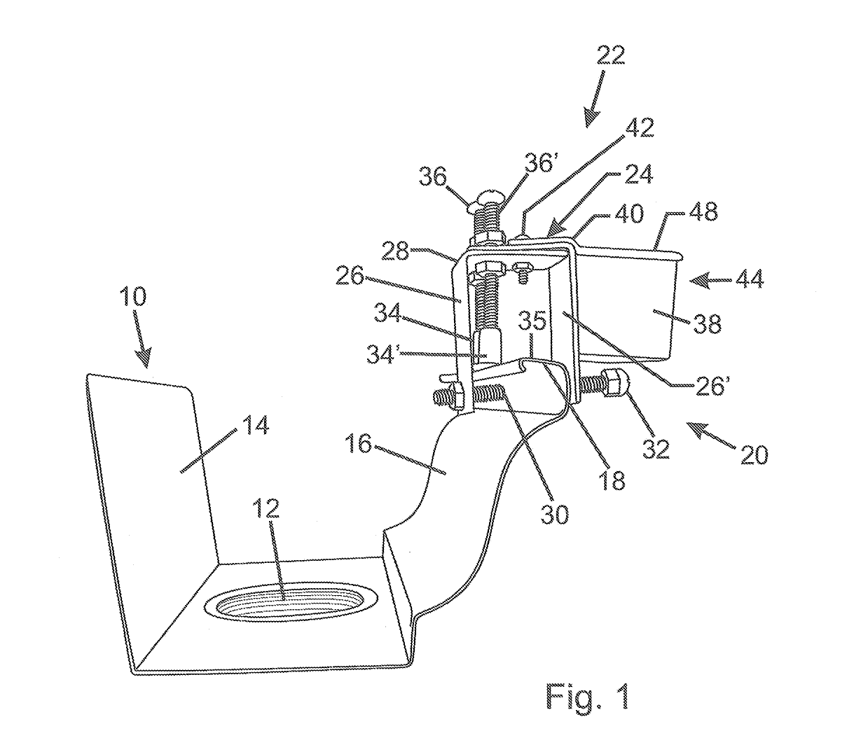

A preferred embodiment of the invention as depicted in FIG. 1 comprises a multi-part rain gauge 20 disposed on gutter 10 (shown as a cross section with downspout 12, interior sidewall 14 of gutter 10, and exterior sidewall 16 of gutter 10 having an upper lip 18 of exterior sidewall 16 of gutter 10). Multi-part rain gauge 20 comprises two essential sections, an attachment section 22, and a collection section 44, and further can utilize a placement extension stick 54.

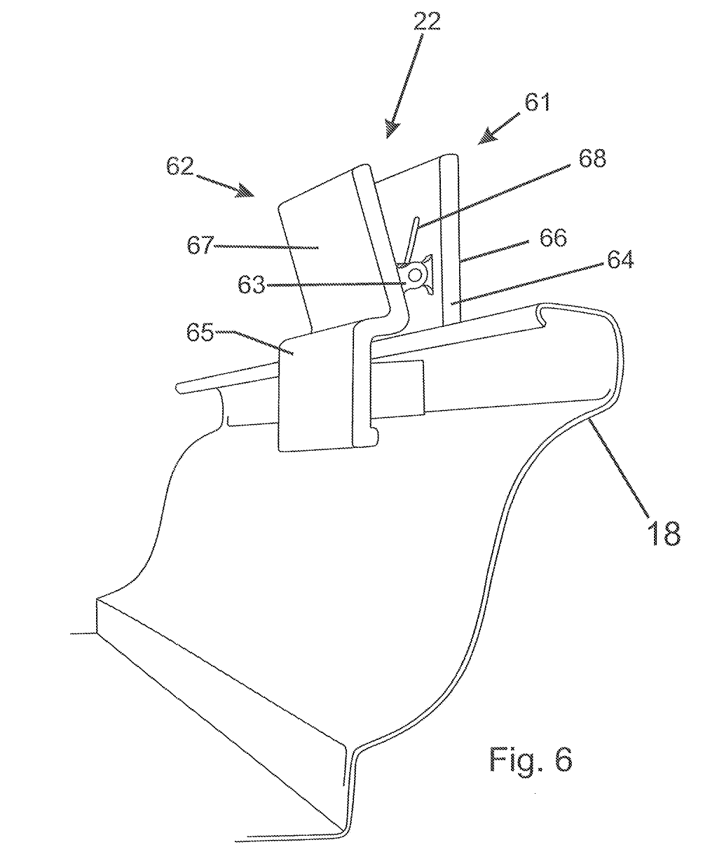

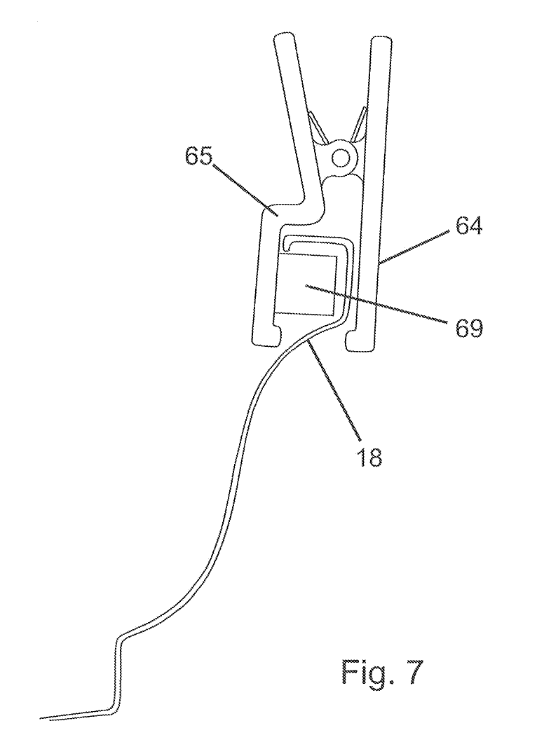

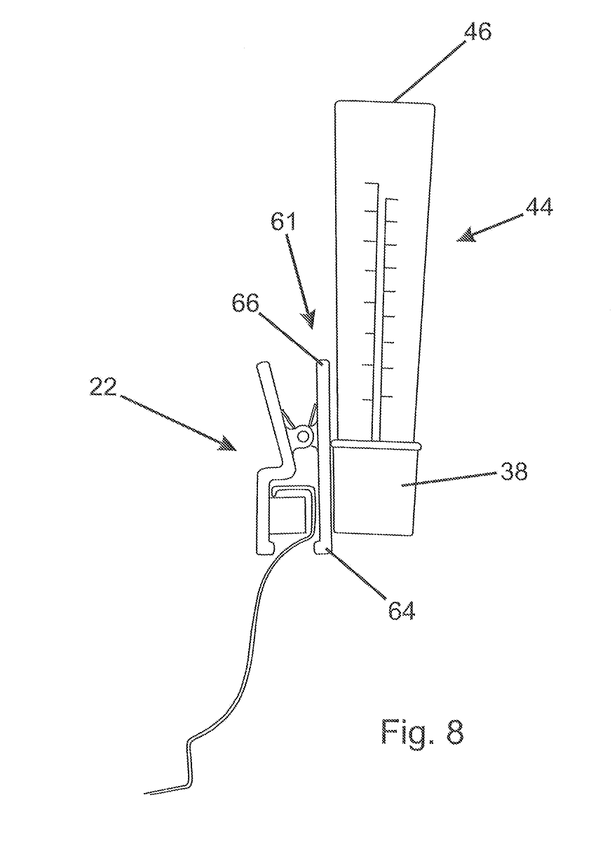

In a preferred embodiment, attachment section 22, is composed of a spring loaded clamp, depicted in isolation in FIG. 6. First clamping member 61 is composed of a first clamping member jaw segment 64 connected to a first clamping member handle segment 66. Similarly, second clamping member 62 is composed of a second clamping member jaw segment 65 and a second clamping member handle segment 67. Clamping member 61 is pivotably joined to clamping member 62 by a hinge joined to second clamping member handle segment 67 and the first clamping member handle segment 66. Spring 68 mutually exerts pressure on the first clamping member 61 and second clamping member of 62 where first clamping member handle segment 66 joins first clamping member jaw segment 64 and also where second clamping member handle segment 67 joins second clamping member jaw segment 65. This provides a closing force whereby attachment section 22 holds fast to the upper lip of sidewall gutter section 18. As can be seen in FIG. 7, clamping jaw 64 and clamping jaw 65 roughly approximate the contour of the upper lip of sidewall gutter section 18. To further accommodate the contour of the gutter lip, block 69 is attached to the interior section of clamping jaw 65. As seen in FIG. 8 the rain gauge receiving cup is attached to first clamping member 61. The attachment may be located on either the jaw 64 of first clamping member 61 or the handle segment 66 of first clamping member 61.

In an alternative embodiment, attachment section 22, in this embodiment comprising in one part a c-clamp 24 having opposing sidewalls 26, 26′ and a rear (upper) side wall 28, a bore through exterior side wall 16 of gutter 10 with a screw 32 or nut and bolt or other fastener known in the art disposed therethrough and through both c-clamp sidewalls 26, 26′. In this preferred embodiment, the device is further steadied with at least one end-capped 34, 34′ bolts 36, 36′ (or screws) extending from the top of device 20 through the rear wall 28 of the c-clamp 24 and onto the upper edge 35 of the upper lip 18 of exterior sidewall 16 of gutter 10. The perpendicularly disposed forces of bolts 36, 36′ and screw 32 secure clamp 24 to gutter 10.

The remainder of attachment section 22 is composed of a rain gauge receiving cup 38. In this preferred embodiment, the cup 38 will have a top lip 40 extending from one side of the upper edge or open end 48 of cup 38. This lip is preferably disposed upon the upper surface of the rear side wall 28 of the c-clamp 24 and affixed to that side wall 28 with means typical to the art such as attachment screw 42 depicted in FIG. 1.

In this preferred embodiment, attachment section 22 joins with collection section 44 by simple insertion of rain gauge vessel 46 into open end 48 of receiving cup 38. In this embodiment vessel 46 and receiving cup 38 gradually increase diameter from bottom to top allowing for a fitted joining. For vessels without such increases in diameter, a deeper receiving cup could be disposed to insure that the vessel would not inadvertently disengage. Also as is known in the art, graduated measuring marks 50 would be disposed as is known in the art on vessel 46.

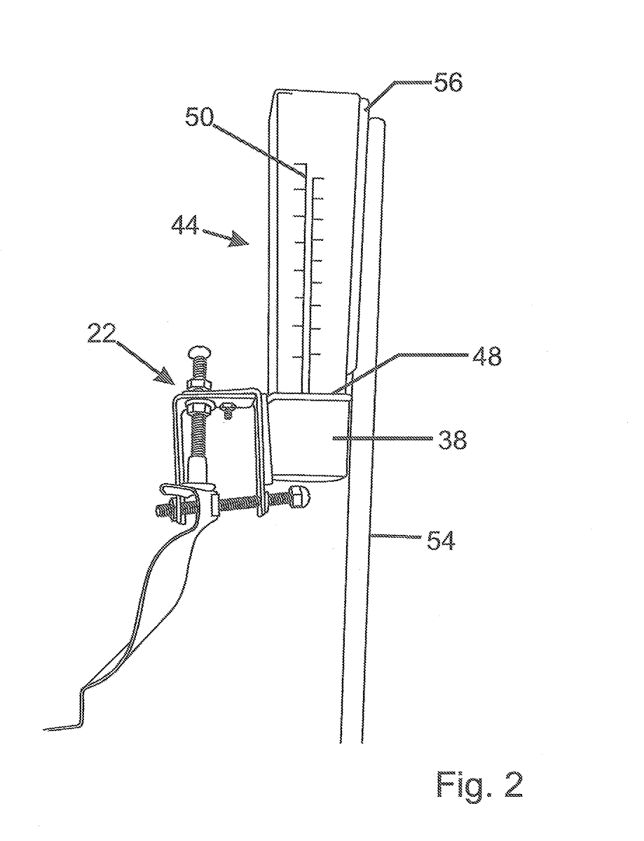

Finally, in the preferred embodiment, an extension stick 54 could be provided to place rain gauge collection vessel 46 within receiving cup 38, allowing a user to place and retrieve the gauge easily without the aid of a ladder. In the simplest preferred embodiment, a suitably long stick 54 would be permanently attached along the length of vessel 46 by affixing the stick to the vessel with an industrial adhesive 56 as shown in FIG. 2.

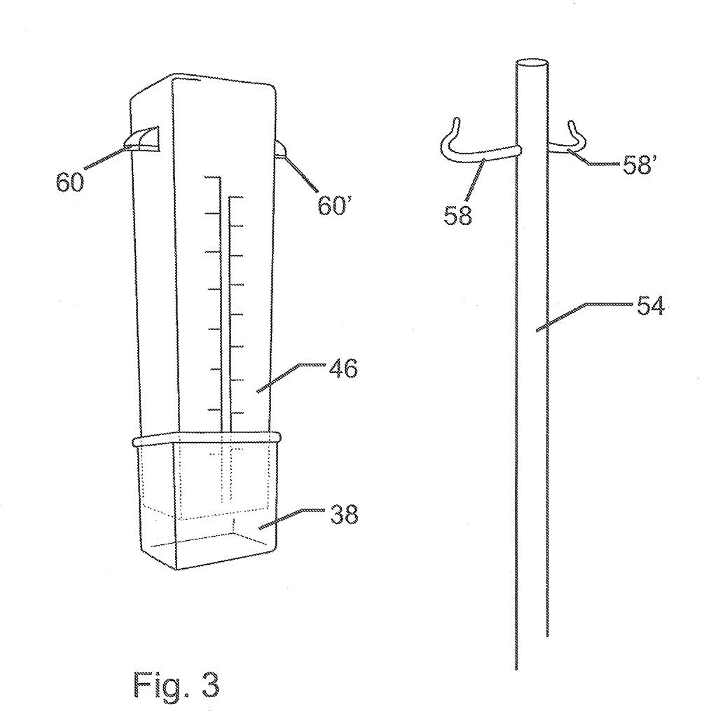

In alternate embodiments such as depicted in FIG. 3, the extension stick 54 could comprise two perpendicular prongs 58, 58′ which could be utilized to lift under alternately provided at least one extension(s) 60, 60′ formed intrinsically with vessel 46 (or applied thereto). In such embodiments the vessel is not affixed to stick 54. The prongs 58, 58′ of extension stick 54 would fit under extensions 60, 60′, preferably in a fitted manner such as inserting into bores through extensions 60, 60′. Alternately, they could “clip” around vessel 46 and under extensions 60, or otherwise fit into an indentation into extensions 60 in order to remove vessel 46 from receiving cup 38 without unintended spilling. Such an extension stick 54 could alternately be devised in sections, in a hinged or other manner (such as linked ascendingly sized cylinders) known in the art to allow the thereby shortened stick to be easily stored. In other embodiments, the stick and vessel could be manufactured of a piece and inseparable, simply “storing” the stick by its permanent attachment hanging alongside the vessel.

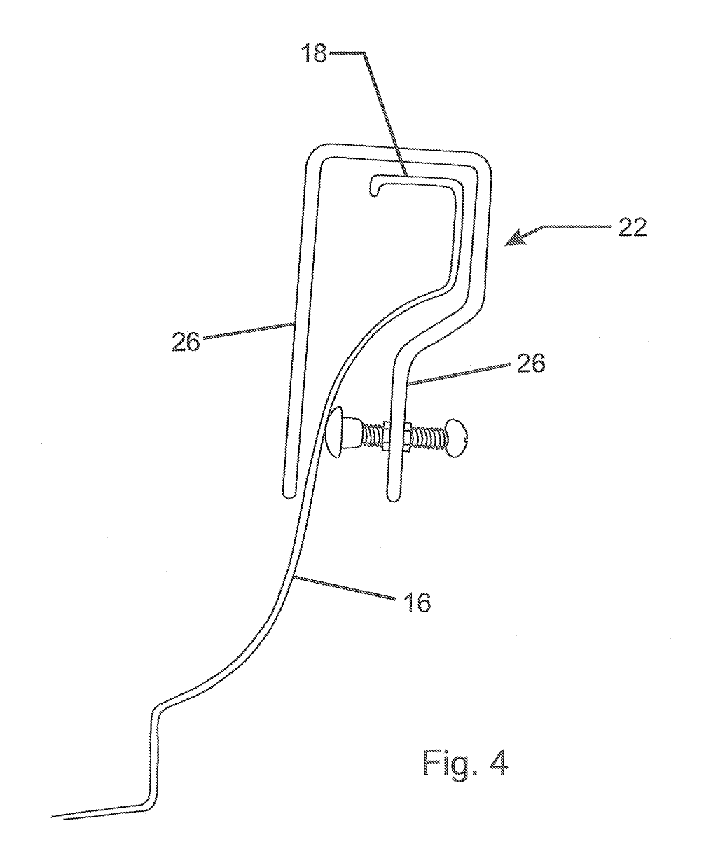

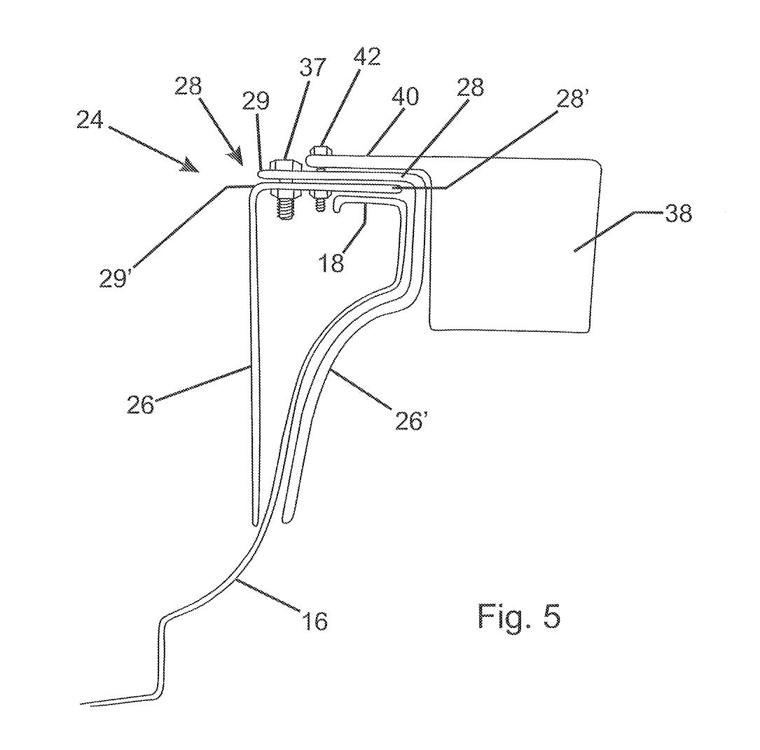

Additional alternate embodiments may utilize a method of attachment to the gutter that requires no bore through the guttering. For instance extending sidewall 26′ in a similar curve below the curve of the lip 18 of the exterior sidewall 16, and then providing a capped screw(s) or bolt(s) extending through sidewall 26 of attachment means 22 to the interior of the gutter lip 18 to affix attachment means 22 to the lip through pressure on both sides of exterior sidewall 16 of gutter 10, as depicted in FIG. 4. It is anticipated that this embodiment would be more difficult to install, requiring more manipulation and strength to maneuver. Therefore, a further alternate embodiment could be a split c-clamp 24, dividing the clamp itself along its rear side wall 28, preferably into two facing pieces 29, 29′ as shown in FIG. 5 which could then utilize a screw or bolt 37 to secure facing pieces 28, 28′ together to serve as rear side wall 28.

It is, of course, anticipated that means known in the art such as screws, nuts, and bolts and the like and combinations thereof could be substituted for those designated herein.

It is further possible that the vessel receiving cup could be attached to the c-clamp or other attachment means via industrial adhesive or by affixing it with screws, nuts, bolts and the like through a side wall or extension disposed alongside the clamp instead of over the top of rear wall 28. The vessel receiving cup, in alternate embodiments also need not be an enclosed vessel. The “cup” may have openings in the bottom to facilitate drainage or may merely comprise a ring or semi-circular extensions (or other shape necessary, for example L-shaped extensions for receipt of a rectangular vessel) suitably shaped to receive the vessel without it falling.

One might think that a simple clip such as those utilized to affix holiday lights to guttering might be similarly utilized, however, a clip of sufficient strength to firmly hold a rain gauge in place without swiveling (that could cause falling, spillage, or inaccurate measure) would require a metal clip of sufficient thickness that a normal individual could not easily dispose such on guttering.

It is also anticipated that someone could utilize the attachment section and vessel section without the extension stick, but the use of the extension stick is a preferred embodiment allowing a user to be able to utilize the device without the inconvenience of a ladder, which for a large proportion of users of these devices is simply not feasible, therefore there is a real need in the art for a conveniently placed rain gauge (on the house), but disposed for accurate collection of rain (without overhang or other sheltering by the house, that can be easily removed from that location for reading and emptying.

I claim:

1. A rain gauge comprising:
a guttering attachment section additionally comprising a rain collection vessel receiving cup fixed thereon; and
a rain collection vessel removably disposed within said rain collection vessel receiving cup.

2. The rain gauge of claim 1 additionally comprising an extension stick for placement of said rain collection vessel within an open end of said rain collection vessel receiving cup and removing same therefrom.

3. The rain gauge of claim 1 wherein said guttering attachment comprises a spring loaded clamp having two opposing jaws which apply pressure to a gutter lip and to opposing gutter sidewalls.

4. The rain gauge of claim 1 wherein said guttering attachment comprises a c-clamp having two opposing side walls with a nut and bolt or screw disposed therethrough and one rear sidewall disposed perpendicularly to said two opposing sidewalls.

5. The rain gauge of claim 1 wherein said guttering attachment comprises a c-clamp having two opposing side walls with at least one of a nut and bolt or screw opposingly disposed through each of said two opposing side walls to an interior section of said c-clamp, wherein said at least one of a nut and bolt or screw additionally comprises end caps disposed thereon for placement against an inside surface of an exterior sidewall of guttering and against an outside surface of an exterior sidewall of guttering.

6. The rain gauge of claim 3 wherein said one rear sidewall rests upon an upper lip of a gutter.

7. The rain gauge of claim 3 wherein said one rear sidewall additionally comprises at least one of a bolt or screw disposed through said rear wall of said c-clamp and which said at least one of a bolt or screw rests upon said upper lip of said gutter.

8. The rain gauge of claim 6 wherein said at least one of a bolt or screw additionally comprises an end cap disposed thereon to rest upon said upper lip of said gutter.

9. The rain gauge of claim 5 wherein one of said opposing sidewalls is curved for receipt of an outside surface of a gutter.

10. The rain gauge of claim 8 wherein said nut and bolt or screw is disposed through only one of said opposing sidewalls curved for receipt of an outside surface of said gutter.

11. The rain gauge of claim 9 wherein said nut and bolt or screw additionally comprises an end cap disposed thereon to rest against an outside surface of said gutter.

12. The rain gauge of claim 3 wherein said two opposing side walls each comprise a perpendicularly extending section wherein said one perpendicularly extending section of one opposing side wall is disposed overtop of another perpendicularly extending section of a second opposing side wall and affixed thereupon to form said rear sidewall.

13. The rain gauge of claim 1 wherein said rain vessel receiving cup additionally comprises a lip for affixing said cup to said guttering attachment section.

14. The rain gauge of claim 1 wherein said rain vessel receiving cup has drainage holes.

15. The rain gauge of claim 1 wherein said rain vessel receiving cup comprises a ring or other non-enclosed geometric form for receipt of a rain collection vessel.

16. The rain gauge of claim 1 wherein said an exterior surface of said rain collection vessel is shaped to essentially fittingly correspond within an interior surface of said rain vessel receiving cup.

17. The rain gauge of claim 2 wherein said extension stick is fixedly connected to said rain collection vessel.

18. The rain gauge of claim 2 wherein said extension stick is extendable.

19. The rain gauge of claim 2 wherein said extension stick comprises attachment means for receipt of said rain collection vessel.

20. The rain gauge of claim 18 wherein said attachment means comprises at least one prong for fitted receipt of said rain collection vessel.

21. A rain gauge comprising:
a guttering attachment section additionally comprising a rain collection vessel receiving cup fixed thereon;
a rain collection vessel disposed within said rain collection vessel receiving cup having measuring indicia disposed thereupon and removable from said rain collection vessel receiving cup; and
an extension stick for placement of said rain collection vessel within an open end of said rain collection vessel receiving cup and removing same therefrom.
